(19) United States
(12) Patent Application Publication
(10) Pub. No.: US 2016/0173454 A1
(43) Pub. Date: Jun. 16, 2016

(54) JURISDICTIONAL CLOUD DATA ACCESS

(71) Applicant: International Business Machines Corporation, Armonk, NY (US)

(72) Inventor: Craig A. Statchuk, Ontario (CA)

(21) Appl. No.: 14/736,467

(22) Filed: Jun. 11, 2015

Related U.S. Application Data
(63) Continuation of application No. 14/570,074, filed on Dec. 15, 2014.

(51) Int. Cl. H04L 29/06; G06F 12/14

(52) U.S. Cl. CPC H04L 63/045; G06F 12/1408; H04L 63/0823; G06F 2212/1052

(57) ABSTRACT

A request from a first user to access data stored in a first location is received. A profile of the first user is determined, wherein the profile includes one or more locations of data storage that the first user is allowed to access. Responsive to the determining the profile of the first user, whether the first location is included in the one or more locations of data storage that the first user is allowed to access is determined. Responsive to determining the first location is included in the one or more locations of data storage the first user is allowed to access, the first user is granted access to the data stored in the first location.

### BACKGROUND OF THE INVENTION

The present invention relates generally to the field of cloud computing, and more particularly to restricting access to data stored in a cloud environment.

Data, and more specifically encrypted data, is often of interest to government agencies that want access to as much data as possible. Particularly of interest is the physical location the data is stored, especially when utilizing a “cloud” environment, wherein large groups of remote servers are networked to allow for centralized data storage and users remotely access the data stored on the “cloud”. Government agencies can request access to data when that data physically resides within their jurisdiction. Additionally, sovereign countries can claim access to data that is physically stored within their geographical boards. Similarly, courts can claim subpoena rights to data stored within the court's jurisdiction.

### SUMMARY

Embodiments of the present invention include a method, computer program product, and system for restricting access to data stored in a distributed computing environment. In one embodiment, a request from a first user to access data stored in a first location is received. A profile of the first user is determined, wherein the profile includes one or more locations of data storage that the first user is allowed to access. Responsive to the determining the profile of the first user, whether the first location is included in the one or more locations of data storage that the first user is allowed to access is determined. Responsive to determining the first location is included in the one or more locations of data storage the first user is allowed to access, the first user is granted access to the data stored in the first location.

### BRIEF DESCRIPTION OF THE DRAWINGS

FIG. 1 depicts a cloud computing node, in accordance with an embodiment of the present invention;

FIG. 2 depicts a cloud computing environment, in accordance with an embodiment of the present invention;

FIG. 3 depicts abstraction model layers, in accordance with an embodiment of the present invention;

FIG. 4 depicts a functional block diagram of a data processing environment, in accordance with an embodiment of the present invention; and

FIG. 5 depicts a flowchart of operational steps of a program for restricting access to data stored in a cloud environment, in accordance with an embodiment of the present invention.

### DETAILED DESCRIPTION

Some embodiments of the present invention recognize that encrypted data is often of interest to government agencies who want access to as much information as possible and, particularly, government agencies have interest in the physical location of cloud data. Currently, government agencies can request access to otherwise proprietary data when the data is physically within their jurisdiction. Additionally, sovereign countries can claim access to data that is physically stored within their geographical boundaries. Similarly, courts can claim subpoena rights when data is stored within its jurisdiction. As such, the location of where data is stored has become important for users of data and vendors who store data in certain legal jurisdictions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

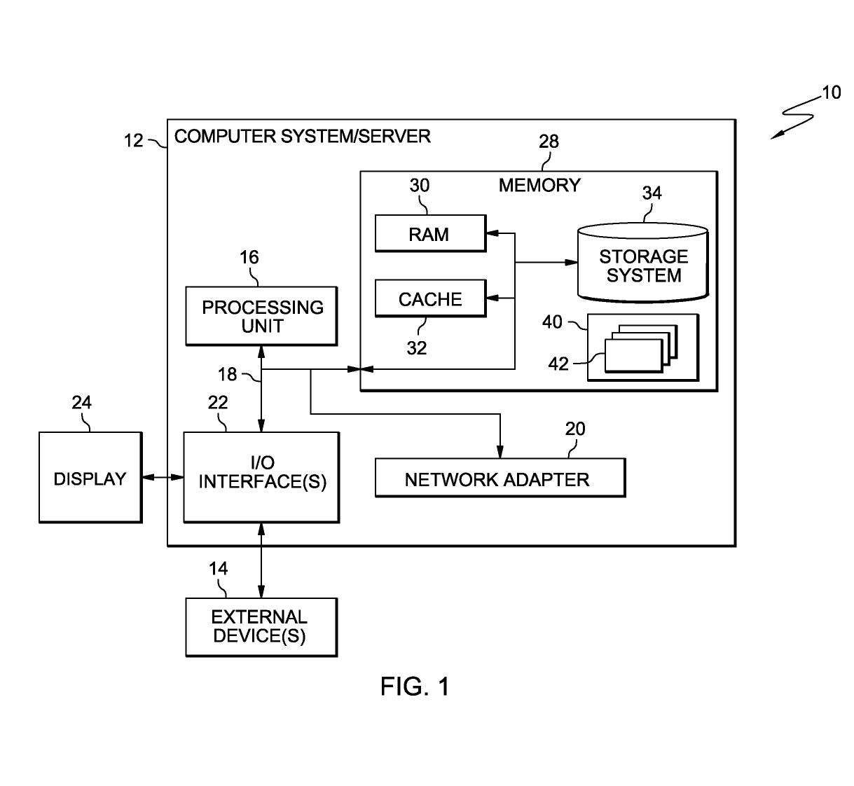

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

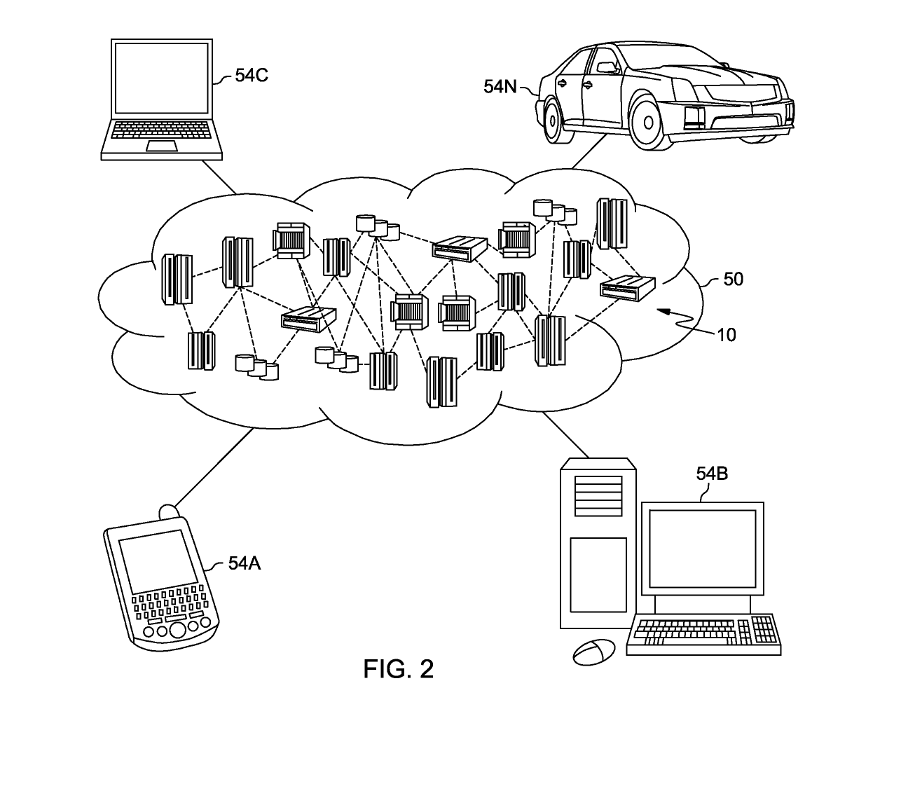

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

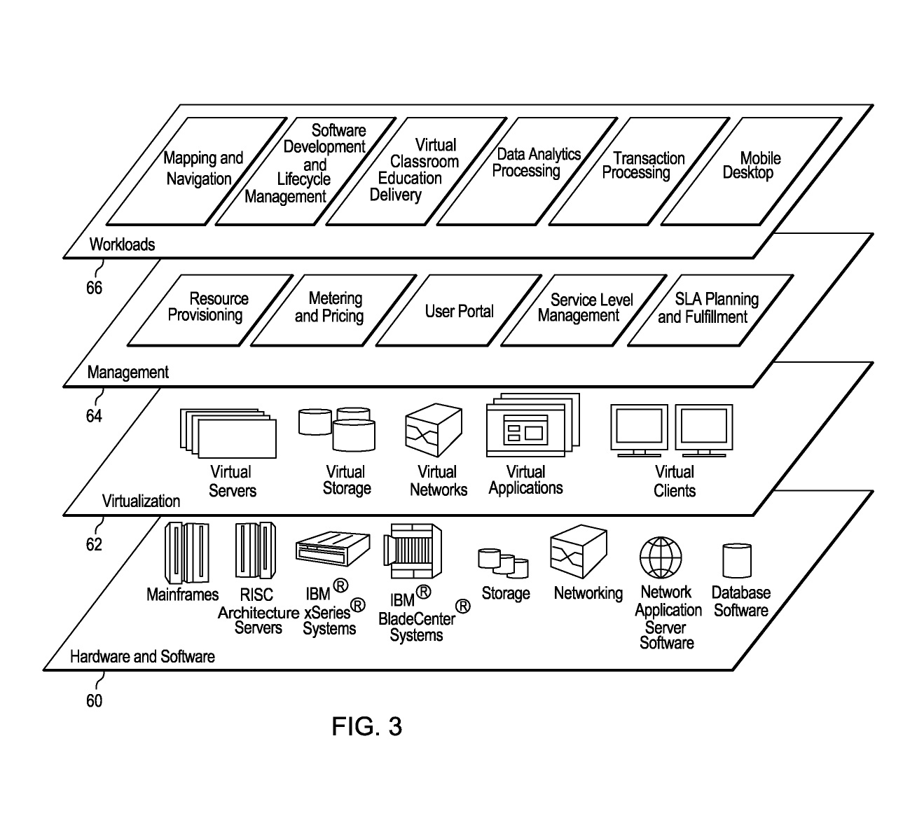

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

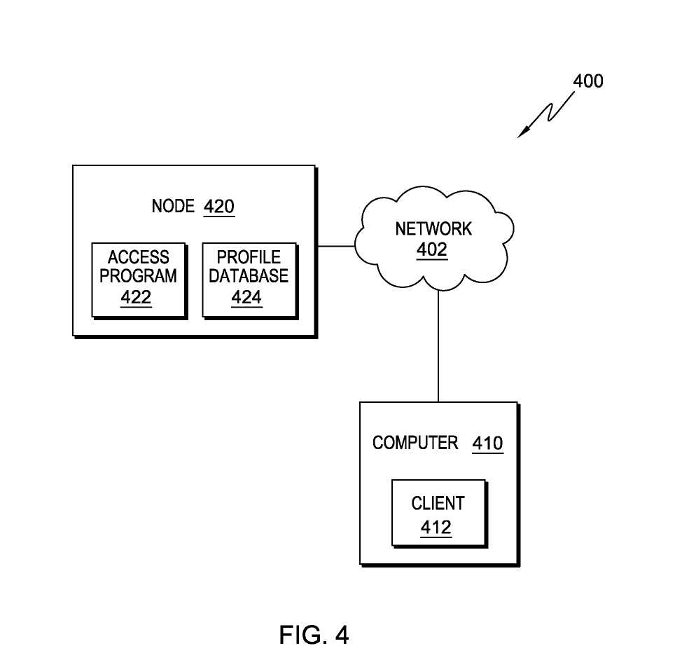

The present invention will now be described in detail with reference to the Figures. FIG. 4 is a functional block diagram illustrating a data processing environment, generally designated 400, in accordance with one embodiment of the present invention. FIG. 4 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

An embodiment of data processing environment 400 includes client computer 410, node 420, interconnected over network 402. Network 402 can be, for example, a local area network (LAN), a telecommunications network, a wide area network (WAN) such as the Internet, or any combination of the three, and include wired, wireless, or fiber optic connections. In general, network 402 can be any combination of connections and protocols that will support communications between client computer 410, node 420, and any other computer connected to network 402, in accordance with embodiments of the present invention.

In example embodiments, computer 410 and node 420 may be a laptop, tablet, or netbook personal computer (PC), a desktop computer, a personal digital assistant (PDA), a smart phone, or any programmable electronic device capable of communicating with any computing device within data processing environment 400. In certain embodiments, computer 410 collectively represents a computer system utilizing clustered computers and components (e.g., database server computers, application server computers, etc.) that act as a single pool of seamless resources when accessed by elements of data processing environment 400, such as in a cloud computing environment. In general, computer 410 is representative of any electronic device or combination of electronic devices capable of executing computer readable program instructions. Computer 410 may include components as depicted and described in detail with respect to cloud computing node 10, as described in reference to FIG. 1, in accordance with embodiments of the present invention.

Computer 410 includes client 412. Client 412 is a program, application, or subprogram of a larger program that allows a user of computer 410 to view and communicate with any application or data found on node 420 or any other node (not shown), discussed in depth later. Client 412 may be similar to a user interface. A user interface (not shown) is a program that provides an interface between a user and an application. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements. For example, client application may be a web browser, a database program, etc.

Node 420 includes access program 422 and profile database 424. Access program 422 is a program, application, or subprogram of a larger program for restricting access to data stored in a cloud environment. Profile database 424 maintains information relating to types of profiles (for example, operator, regulator, etc.), which users have each type of profile, and what jurisdictional access each profile has.

Access program 422 is a program, application, or subprogram of a larger program that restricts access to data stored in a cloud environment. In an embodiment, access program 422 may monitor data stored exclusively on node 420. In an alternative embodiment, access program may be located on node 420 but monitor data stored on other nodes (not shown) as well. Access program 422 receives data, and the data is stored on node 420 in traditional manners or receives information about data stored on other nodes (not shown). Access program 422 determines the jurisdictional access of the data, in other words the location of the data, and then generates a private/public key pair for the piece of data. Each private/public key pair is related to the location that the data is stored and each piece of data that is located in the same place has the same private/public key pair. In other words, there is a private/public key pair for each location and all data stored in that location uses the private/public key pair for that location. The private/public key pair remains the same for the location until the location changes and at that time a new private/public key pair is generated that is associated with the new location. Public-key cryptography, also known as asymmetric cryptography, is a class of cryptographic algorithms which requires two separate keys, one of which is secret (or private) and one of which is public. The public key is used to encrypt plaintext or to verify a digital signature and the private key is used to decrypt ciphertext or to create a digital signature. The public key may be distributed through traditional manners including, but not limited to, a website or email.

Next, access program 422 defines the profiles, which users are included in each profile, the locations of data storage that each profile has access to, and the private/public key pair for each profile and/or user. In an embodiment, the private/public key pair may change when there are changes to the users in a profile. Access program 422 receives a data access request from a user and then determines if the user's associated profile has permission to access the data requested, based on the requested data's location. If the user has permission to access the location the data is found within, access program 422 grants the user access to the data. Alternatively, if the user does not have permission to access the location the data is found within, access program 422 does not allow the user access to the data. Access program 422 may be found in the workloads layer 66, as described in reference to FIG. 3, discussed previously.

Profile database 424 may include data relating to profiles (for example, operators, regulators, etc.), which users have which profile, and what jurisdictional access each profile has. Profile database may include at least one profile. For example, there may be an Operator profile (setup for users that work on data) and a Regulator profile (setup for government agencies). In an embodiment, there may be multiple versions of a profile such as Operator A, Operator B, Operator C. Each profile has at least one user associated with it. In an embodiment, there may be multiple users associated with each profile. In other words, Operator A profile may include User A, User B, and User C. In an alternative embodiment, there may be only one user associated with each profile. In other words, Operator A profile may only be User A. Each profile has a jurisdictional access associated with it. The jurisdictional access is an area where data is located that the profile can access. In other words, each profile can access data in certain location(s). The jurisdictional access may be defined by a geographic location, such as North America, the United States, or New Jersey. Alternatively the jurisdictional access may be defined by an area created by the administrator or manager of the data. In yet another alternative, the jurisdictional access may be any combination of the previous examples. For example, the Operator profile may be able to access data in location A, location B, and location C. Alternatively, the Regulator profile may be able to access data only in location A.

Profile database 424 may also include the public key for each public key/private key pair for each profile or user. The public key/private key pair for each profile or user is generated locally, in other words on the user's device (for example, computer 410), and the public key is made available for storage in profile database 424. In an embodiment, each profile has a public key/private key pair that is associated with all users in that profile. In an alternative embodiment, each user has their own individual public key/private key pair. The public key for the profile/user is used to encrypt data so that only the person who has the associated private key can decrypt and view the data. The information found on profile database 424 may be created by an administrator or manager of a dataset upon initializing access program 422. Additionally, an administrator or manager may update or edit any of the information found in profile database 424 at any time.

Profile database 424 resides on node 420. In an alternative embodiment, profile database 424 may reside on another device or computer within data processing environment 400 or any other device not within data processing environment 400, accessible via network 402. A database is an organized collection of data. Data found in a database is typically organized to model relevant aspects of reality in a way that supports processes requiring the information found in the database. Profile database 424 can be implemented with any type of storage device capable of storing data that may be accessed and utilized by computer 410, such as a database server, a hard disk drive, or a flash memory. In other embodiments, profile database 424 can be implemented with multiple storage devices within computer 410.

Alternatively, profile database 424 can be implemented with any computer readable storage medium as found in the art. For example, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

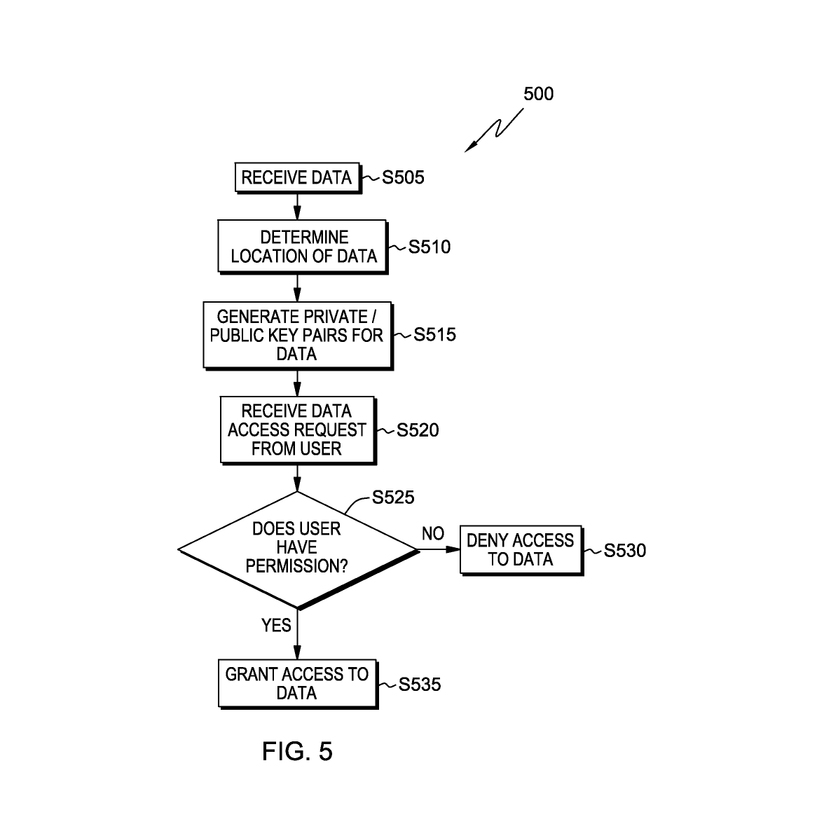

FIG. 5 is a flowchart of workflow 500 depicting operational steps for restricting access to data stored in a cloud environment, in accordance with an embodiment of the present invention. In one embodiment, the steps of the workflow are performed by access program 422. Alternatively, steps of the workflow can be performed by any other program while working with access program 422. In a preferred embodiment, a user, via a user interface discussed previously, can invoke workflow 500 upon determining that they would like to access a piece of data that is stored in a cloud environment. In an alternative embodiment, workflow 500 can be invoked automatically under the control of another program, for example, upon a piece of data being stored on node 420 or an administrator creating or editing profile information, access program 422 may begin a step in workflow 500.

Access program 422 receives data (step S505). Data can be defined as a set of values of qualitative or quantitative variables, in other words a piece of data is individual pieces of information. In other words, data is a data packet that is a series of bytes that consist of any type of binary encoded data including text and program code. For example, in an email environment, the pieces of data may be each individual email, in a big data environment each piece of data may be a spreadsheet of numbers and words, in a programming environment each piece of data may be an application, program, or subprogram. Access program 422 is notified of least one piece of data that will be stored on node 420. In alternative embodiment, access program is notified of at least piece of data that is stored on other nodes (not shown) but access program 422 has control over those pieces of data.

Access program 422, or any other traditional program working with access program 422, stores the data on node 420 or other nodes (not shown). The data may be sent to access program 422 by a user via client 412 using computer 410 over network 402. Alternatively, the data may already be stored on node 420 and a user, via client 412, may indicate to access program 422 that the data needs to be under the authority and control of the access program 422. In yet another alternative, the data may be stored on another node (not shown) and a user, via client 412, may indicate to access program 422 that the data needs to be under the authority and control of the access program 422. In other words, access program 422 will control access attempts by users to pieces of data that are not stored on the same node as access program 422. For example, access program 422 receives DataA from the user, via client 412 using computer 410, for storage on node 420. Additionally, access program 422 receives an indication that DataB and DataC, each located on another node (not shown), will be under the authority and control of access program 422.

Access program 422 determines the location of the data (step S510). Access program 422 determines the location where the data, received in the previous step, is stored. In other words, the data is stored in a specific physical location and access program 422 determines that specific physical location. In an embodiment, the specific physical location where the data is stored can be determined using conventional methods known in the art, such as secure shell (SSH), secure socket layer (SSL), IP Security Protocol Suite (IPSec), etc. In the previously discussed example, DataA, stored on node 420, is located at LocationA. DataB is stored on a node (not shown) located at LocationB. DataC is stored on a node (not shown) located at LocationC.

Access program 422 generates private/public key pairs for each piece of data (step S515). As discussed previously, public-key cryptography, in conjunction with Secure Socket Layer (SSL) or Transport Layer Security (TLS) and other methods, such as IP-to country determination, is used to validate the location the data is stored. Each location that data is stored will have a private/public key pair associated with it. For example, LocationA will have private/public key pair A, LocationB will have private/public key pair B, and LocationC will have private/public key pair C. DataA, stored in LocationA, will be encrypted with private key A, DataB, stored in LocationB, will be encrypted with private key B, and DataC, stored in LocationC, will be encrypted with private key C. The data is encrypted with the private key that corresponds to the location the data is stored so that when a user receives a piece of data, a user can decrypt the piece of data using the public key corresponding to the private key for the location the data came from, and in doing so, this confirms that the piece of data came from the server located with the associated private/public key pair.

Access program 422 receives a data access request from a user (step S520). In other words, a user, via client 412 using computer 410 requests access to a piece of data. The data requested by the user does not necessarily have to be under the control or authority of access program 422. Access program 422 can only grant access to data that is under the control or authority of access program 422. In an embodiment, the user may request a single piece of data, for example a word document. In an alternative embodiment, the user may request multiple pieces of data at the same time, for example an application that has multiple data files associated with it.

Access program 422 determines if the user has permission to access the requested data (decision block S525). In other words, based on the profile that the user has does that profile allow access by the user to the requested data. Access program 422, based on the user, will determine what profile the user has. For example, User A and User B fall under the Operator profile and User C falls under the Regulator profile. If User A makes the data request then the Operator profile will be used and if User C makes the data request the Regulator profile will be used. Access program 422 determines, based on the profile of the user, the jurisdictional access for the user. In other words, the user, based on the profile associated with the user, is granted access to specific jurisdictions or locations. Access program 422 determines the location of the data based on information determined previously in step S510. Access program 422, based on the specific jurisdictions or locations that the user is granted access to, determines if the user is allowed to access the data, based on the location of the data determined previously.

If the user does not have permission to access the data (decision block S525, no branch), the user is denied access to the data (step S530). In other words, access program 422 will not allow the user to access the data that they do not have permission to access. In an embodiment, if one piece of data is requested and the user is denied access to the data, the piece of data will not be displayed for the user. In an alternative embodiment, if multiple pieces of data are requested and the user is granted access to some of the data and denied access to some of the data, only the data that is allowed to be accessed will be shown. In all embodiments, the user will not be notified that the data that they do not have permission to access actually exists. In other words, when a user requests pieces of data, only the data the user has permission to access will be returned to the user and the user will not be notified that they did not have permission to access certain pieces of data.

If the user has permission to access the data (decision block S525, yes branch), the user is granted access to the data (step S535). In other words, access program 422 will allow the user to access the data that they have permission to access. Similar to the previous step S530, access program 422 can grant access to some or all of the data requested. Once access program 422 determines that a user has permission to access the data then access program 422 encrypts the data.

In an embodiment, the data may be encrypted with the user's public key. In an alternative embodiment, the data may be encrypted with the profile's public key that the user is a member of. For example, if user A is granted access to DataA, then DataA is encrypted with user A's public key. In another example, if a user A is granted access to DataA and user A is a member of the Operator profile, DataA is encrypted with the Operator public key. The user can then decrypt the data using their private key and then access the data.

Additionally, the data is encrypted with the private key that corresponds to the location the data is stored. The user utilizes the public key that corresponds to the location the data is stored to decrypt the data so that when a user receives the piece of data the user confirms that the piece of data came from the server located with the associated private/public key pair, discussed previously. In this embodiment, the user accesses the data via client 412 using computer 410 and the data remains on node 420 or any other node (not shown).

In an alternative embodiment, the user can download the data temporarily to another computer, for example computer 410. The downloaded data is then encrypted with an additional private/public key pair associated with the computer which downloaded the data temporarily, for example computer 410, which ensures that when the data is returned to the original storage location, it is the correct data. The following example depicts how Client A gets Data D from Server B. First, access program 422 receives a public key, Public A, that is part of a public/private key pair PrivateA and Public A for Client A from Client A. Next, access program 422 generates public/private key pair PrivateB and PublicB for Server B. Next, Client A requests, via access program 422, DataD stored on Server B. Access program 422 decrypts DataD using PrivateB to create DataDB. Due to the encryption using PrivateB, Client A will know that DataDB came from Server B. Checksums or other accepted methods can be added to DataD before it is encoded to provide proper decoding in a subsequent step. Access program 422 encrypts DataDB using PublicA to create DataDBA. Due to the encryption using PublicA, only Client A can decrypt DataDBA. Access program 422 transmits DataDBA from Server B to Client A. When Client A wants to work temporarily on with DataD, Client A decodes DataDBA, received previously, with PrivateA and PublicB to get DataD and then Client A discards its temporary copy of Data D when finished working. Should Client A need to save DataD for any reason, Client A saves the copy of DataDBA, received previously. When a user without the same jurisdictional access as Client A, for example a Regulator, wants to see the contents of DataDBA, access program 422 can prove to the Regulator that DataDBA decodes to DataDB using PrivateA proving that DataDB was intended for Client A and that DataDB decodes to DataD using PublicB proving DataB came from Server B. Access program 422 has proven to the regulator that DataB came to Client A from Server B and the Regulator cannot have access to DataB since the Regulator does not have jurisdictional access to the location of Server B.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer program product for restricting access to data stored in a distributed computing environment, the computer program product comprising:
one or more computer readable storage media; and
program instructions stored on the one or more computer readable storage media, the program instructions comprising:
program instruction to receive a request from a first user to access data stored in a first location;
program instructions to determine a profile of the first user, wherein the profile includes one or more locations of data storage that the first user is allowed to access;
program instructions, responsive to determining the profile of the first user, to determine whether the first location is included in the one or more location of data storage that the first user is allowed to access; and
program instructions, responsive to determining the first location is included in the one or more locations of data storage that the first user is allowed to access, to grant the first user access to the data stored in the first location.

2. The computer program product of claim 1, further comprising program instructions, stored on the one or more computer readable storage media, to:
receive the data, wherein the access to the data is restricted.

3. The computer program product of claim 1, further comprising program instructions, stored on the one or more computer readable storage media, to:
receive at least one profile, wherein each profile has at least one user associated with the profile, each profile is allowed to access data stored in one or more locations, and each profile has a first public/private key pair associated with the profile, wherein the first public/private key pair is at least a first public key and a first private key.

4. The computer program product of claim 3, further comprising program instructions, stored on the one or more computer readable storage media, to:
generate a second public/private key pair associated with the first location, wherein the second public/private key pair is at least a second public key and a second private key.

5. The computer program product of claim 4, wherein program instructions to grant the first user access to the data stored in the first location comprise:
program instructions to encrypted the data with the first public key and the second private key; and
program instructions to grant the first user access to the encrypted data.

6. The computer program product of claim 5, further comprising program instructions, stored on the one or more computer readable storage media, to:
transmit the encrypted data to the first user.

7. The computer program product of claim 6, wherein the transmitted encrypted data can only be decrypted by the first private key and the second public key pair.

8. A computer system for restricting access to data stored in a distributed computing environment, the computer program product comprising:
one or more computer processors:
one or more computer readable storage media; and
program instructions stored on the one or more computer readable storage media, the program instructions comprising:
program instruction to receive a request from a first user to access data stored in a first location;
program instructions to determine a profile of the first user, wherein the profile includes one or more locations of data storage that the first user is allowed to access;
program instructions, responsive to determining the profile of the first user, to determine whether the first location is included in the one or more location of data storage that the first user is allowed to access; and
program instructions, responsive to determining the first location is included in the one or more locations of data storage that the first user is allowed to access, to grant the first user access to the data stored in the first location.

9. The computer system of claim 8, further comprising program instructions, stored on the one or more computer readable storage media for execution by at least one of the one or more computer processors, to:
receive the data, wherein the access to the data is restricted.

10. The computer system of claim 8, further comprising program instructions, stored on the one or more computer readable storage media for execution by at least one of the one or more computer processors, to:
receive at least one profile, wherein each profile has at least one user associated with the profile, each profile is allowed to access data stored in one or more locations, and each profile has a first public/private key pair associated with the profile, wherein the first public/private key pair is at least a first public key and a first private key.

11. The computer system of claim 10, further comprising program instructions, stored on the one or more computer readable storage media for execution by at least one of the one or more computer processors, to:
generate a second public/private key pair associated with the first location, wherein the second public/private key pair is at least a second public key and a second private key.

12. The computer system of claim 11, wherein program instructions to grant the first user access to the data stored in the first location comprise:
program instructions to encrypted the data with the first public key and the second private key; and
program instructions to grant the first user access to the encrypted data.

13. The computer system of claim 12, further comprising program instructions, stored on the one or more computer readable storage media for execution by at least one of the one or more computer processors, to:
transmit the encrypted data to the first user.

14. The computer system of claim 13, wherein the transmitted encrypted data can only be decrypted by the first private key and the second public key pair.
